(19) United States
(12) Patent Application Publication
(10) Pub. No.: US 2021/0341948 A1
(43) Pub. Date: Nov. 4, 2021

(54) DETERMINING LIKELIHOOD OF FAILURE OF AN AERIAL VEHICLE

(71) Applicant: Loon LLC, Mountain View, CA (US)

(72) Inventors: Anselm Lau, Sunnyvale, CA (US); Derek Herbert, Mountain View, CA (US)

(21) Appl. No.: 16/861,964

(22) Filed: Apr. 29, 2020

(51) Int. Cl. G05D 1/06; G05D 1/00; B64C 39/02; B64F 5/60

(52) U.S. Cl. CPC G05D 1/0688; G05D 1/005; B64C 2201/146; B64F 5/60; B64C 39/024

(57) ABSTRACT

Aspects of the disclosure provide methods for determining a likelihood of failure of an aerial vehicle. In one instance, the method may include receiving a first rotation rate of an impeller of an altitude control system of the aerial vehicle. A model may be used to determine a second impeller rotation rate, wherein the second rotation rate is an idealized impeller rotation rate. The first rotation rate may be compared to the second rotation rate. Based on the comparison, the likelihood of failure may be determined.

### BACKGROUND

Aerial vehicles, such as balloons, may operate at substantial altitudes. Such vehicles may operate within the Earth's stratosphere, having favorably low wind speeds at an altitude between 18 and 25 km (11-15 mi). Wind speed and wind direction vary at certain altitudes, allowing unmanned vehicles to rely on the wind speed and wind direction alone for navigation, without the need for additional propulsion means. Such aerial vehicles must therefore increase or decrease their altitude to change course or to increase speed and thus require altitude control systems to accomplish this.

### BRIEF SUMMARY

Aspects of the disclosure provide a method for determining a likelihood of failure of an aerial vehicle. The method includes receiving, by one or more processors, a first rotation rate of an impeller of an altitude control system of the aerial vehicle; using, by one or more processors, a model to determine a second rotation rate, wherein the second rotation rate is an idealized impeller rotation rate; comparing, by one or more processors, the first rotation rate to the second rotation rate; and determining, by one or more processors, the likelihood of failure of the aerial vehicle based on the comparison.

In one example, the one or more processors are one or more processors of the aerial vehicle. In another example, the one or more processors are one or more processors of a computing device remote from the aerial vehicle. In another example, the model is a machine learned model. In another example, the method also includes comparing the likelihood of failure to a threshold value and initiating an intervention action based on the comparison of the likelihood of failure to the threshold value. In this example, the intervention action includes sending a notification for display to a human operator. In addition or alternatively, the intervention action includes automatically causing the aerial vehicle to terminate a flight of the aerial vehicle. In addition or alternatively, the method also includes determining the threshold value based on an amount of time for the aerial vehicle to reach a designated landing area. In addition or alternatively, the method also includes determining the threshold value based on a distance the aerial vehicle needs to travel to reach a designated landing area.

Another aspect of the disclosure provides a method of training a model for determining an ideal impeller rotation rate for an impeller of an altitude control system of an aerial vehicle. The method includes receiving, by one or more processors, training data, the training data including training inputs including input power to a motor controller of an altitude control system of a first aerial vehicle, a pressure ratio between an inlet and an outlet of a compressor of the altitude control system of the first aerial vehicle, back pressure on the impeller from an envelope of the first aerial vehicle, ambient temperature inside of the envelope of the first aerial vehicle, and the training data further including a training output including a rotation rate of the impeller of the first aerial vehicle. The training data was collected during a particular descent cycle of the first aerial vehicle. The method also includes training the model using the training data.

In one example, the training inputs further include shroud temperature of the compressor of the first aerial vehicle. In another example, the particular descent cycle is a descent cycle of the altitude control system of the first aerial vehicle which occurs after a steady-state has been reached. In another example, the particular descent cycle is a descent cycle of the altitude control system of the first aerial vehicle which occurs after a minimum number of descent cycles have been completed. In another example, the particular descent cycle is a descent cycle of the altitude control system of the first aerial vehicle having a minimum number of samples. In another example, the particular descent cycle is a descent cycle of the altitude control system of the first aerial vehicle lasting at least a predetermined period of time.

Another aspect of the disclosure provides a method of training a model for determining an ideal shroud temperature for an impeller of an altitude control system of an aerial vehicle. The method includes receiving, by one or more processors, training data, the training data including training inputs including input power to a motor controller of an altitude control system of a first aerial vehicle, a pressure ratio between an inlet and an outlet of a compressor of the altitude control system of the first aerial vehicle, backpressure on the impeller from an envelope of the first aerial vehicle, ambient temperature inside of the envelope of the first aerial vehicle, and the training data further including a training output including a shroud temperature of a compressor of the first aerial vehicle. The training data was collected during a particular descent cycle of the first aerial vehicle. The method also includes training the model using the training data.

In this example, the particular descent cycle is a descent cycle of the altitude control system of the first aerial vehicle which occurs after a steady-state has been reached. In another example, the particular descent cycle is a descent cycle of the altitude control system of the first aerial vehicle which occurs after a minimum number of descent cycles have been completed. In another example, the particular descent cycle is a descent cycle of the altitude control system of the first aerial vehicle having a minimum number of samples. In another example, the particular descent cycle is a descent cycle of the altitude control system of the first aerial vehicle lasting at least a predetermined period of time.

### BRIEF DESCRIPTION OF THE DRAWINGS

FIG. 1 is a functional diagram of a system in accordance with aspects of the present disclosure.

FIG. 2 is an example of a balloon in accordance with aspects of the present disclosure.

FIG. 3 is an example of a balloon in flight in accordance with aspects of the disclosure.

FIG. 4 is an example altitude control system in accordance with aspects of the disclosure.

FIG. 5 is an air compressor in accordance with aspects of the disclosure.

FIG. 6 is a cross-sectional view taken along line A-A of FIG. 5.

FIG. 7 is an example block diagram of a control system in accordance with aspects of the disclosure.

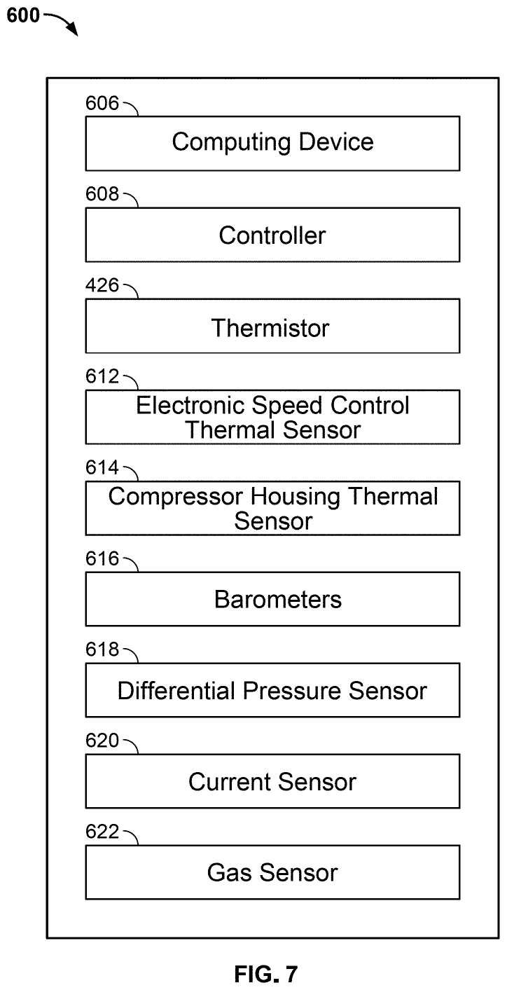

FIG. 8 is an example block diagram of a ground station in accordance with aspects of the disclosure.

FIG. 9 is an example flow diagram in accordance with aspects of the disclosure.

FIG. 10 is an example flow diagram in accordance with aspects of the disclosure.

FIG. 11 is an example plot of data in accordance with aspects of the disclosure.

FIGS. 12A and 12B are example plots of data in accordance with aspects of the disclosure.

FIG. 13 is an example flow diagram in accordance with aspects of the disclosure.

FIG. 14 is an example flow diagram in accordance with aspects of the disclosure.

### DETAILED DESCRIPTION

### Overview

The technology relates to assessing the likelihood of failure of an altitude control system of an aerial vehicle. For instance, an altitude control system failure may inhibit an aerial vehicle's ability to steer and navigate. Thus, predicting a likelihood of such failures in advance may enable the aerial vehicle to land safely before such a failure occurs.

An altitude control system may include various features such as compressor including a motor and an impeller or fan. The compressor can be used to force air into or out of an envelope of an aerial vehicle in order to increase or decrease the mass of the aerial vehicle. The result of this is a corresponding decrease or increase in elevation of the aerial vehicle.

In order to assess the likelihood of failure of an altitude control system of an aerial vehicle, flight telemetry data may be accessed by one or more server computing devices. The flight telemetry may be sent by the aerial vehicles of the system, and stored in the memory of the server computing devices or a storage system which can be accessed by the server computing devices. The flight telemetry data used by the server computing devices may be collected during early-life altitude control system mechanical operations to develop a machine-learning model.

The model may be used to output “idealized impeller rotation rate” or “idealized shroud temperature” corresponding to an altitude control system that has endured minimal degradation. For the same power input, energy may be consumed as impeller rotation motion (measured through rotation rate) or dissipated as heat (measured through shroud temperature). Thus, either value may be used as a proxy for degradation of the altitude control system.

For the idealized impeller rotation rate, a model may be trained by the server computing devices using various training inputs and training outputs. The training inputs may include the aforementioned telemetry data. This telemetry data may include various values observed early in the life of compressors. In this example, the impeller rotation rate observed early in the life of the compressor may be used as training outputs. Impeller rotation rate may be determined from feedback from a speed controller of the compressor's motor, e.g. from an internal tachometer which is based around measuring the back electromotive force (EMF) from the motor poles as they rotate inside the stator.

Alternatively, when the model is to be used to determine an idealized shroud temperature, the training inputs may also include the impeller rotation rate. In addition, the ambient or shroud temperature of the compressor observer early in the life of the compressor may be used as training outputs.

The model may then be used by the server computing devices and/or by a computing device of the aerial vehicle in order to assess the likelihood of failure during flight of an aerial vehicle. This assessment may be performed by the server computing devices or the computing device of the aerial vehicle in real time in response to telemetry information from the various systems of the aerial vehicle is received either at a computing device of the aerial vehicle or at a remote computing device, such as a server computing device on the ground.

As altitude control system compressor usage increase, the impeller rotation rate may be expected to decrease due to degradation that occurs due to (1) mechanical loss due to increased friction (in part, caused by migration of lubricants such as grease) and (2) friction increase due to spalling or cracking on bearing surfaces. As a result, the impeller's rotation rate may be expected to decrease over time assuming ambient and operating variables are held constant. The measure of decrease may be considered a degradation measure. Similarly, observations of aerial vehicles which have failed have indicated an increase in shroud temperature in some instances prior to such failures. In this regard, the measure of increase may be considered a degradation measure.

At a certain point, the likelihood of failure may be such that some intervention action may need to be taken. The intervention action may include providing a notification for display to a human operator. Alternatively, that the flight of the aerial vehicle should be terminated may be automatically determined by the server computing devices or a computing device of the aerial vehicle prior to a total failure occurring. In such an example, the system may identify a closest or other designated landing area. As another alternative, rather than terminating the flight of an aerial vehicle, the server computing devices may also use the degradation measure to assign flights or missions to the aerial vehicles.

The features described herein may provide for a useful way to assess likelihood of failure of an aerial vehicle related to the aerial vehicle's altitude control system or compressor. Typical approaches for estimating likelihood of failure may analyze the temperature of the features of the altitude control system, to determine whether the compressor is overheating. However, the increase in temperature to the point of overheating typically occurs after the change in rotation rate and in many instances after it may be too late to safely navigate the aerial vehicle to a designated landing area. In that regard, a prognostic model to trend versus the telemetry observation of gross failure which relies on rotation rate or shroud temperature as described herein can actually allow for assessment of a likelihood of failure earlier in time as compared to using temperature measurements alone.

### EXAMPLE NETWORK

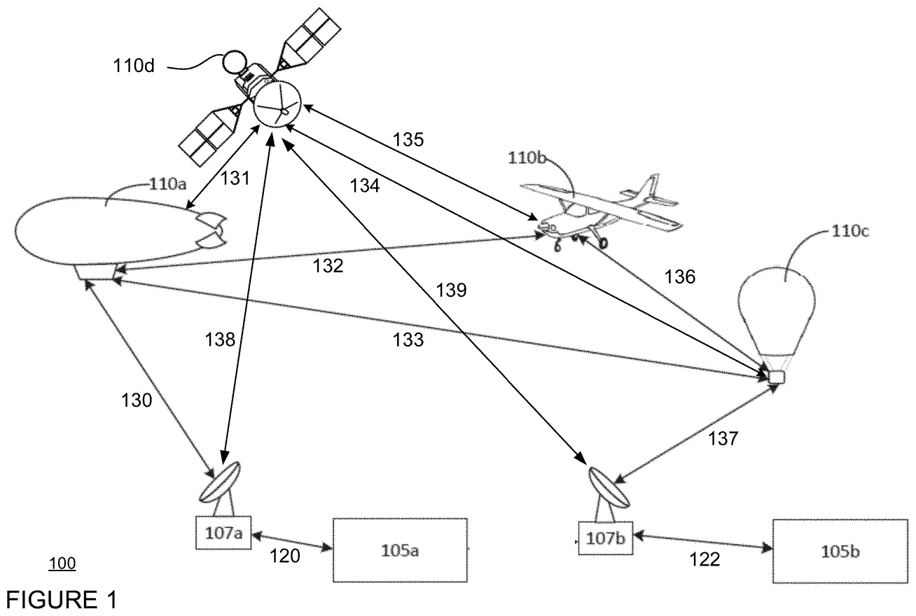

FIG. 1 is a block diagram of an example directional point-to-point network 100.

The network 100 is a directional point-to-point computer network consisting of nodes mounted on various land- and air-based devices, some of which may change position with respect to other nodes in the network 100 over time. For example, the network 100 includes nodes associated with each of two land-based datacenters 105a and 105b (generally referred to as data centers 105), nodes associated with each of two ground stations 107a and 107b (generally referred to as ground stations 107), and nodes associated with each of four airborne high altitude platforms (HAPs) 110a-110d (generally referred to as HAPs 110). As shown, HAP 110a is an aerial vehicle (here depicted as a blimp), HAP 110b is an airplane, HAP 110c is an aerial vehicle (here depicted as a balloon), and HAP 110d is a satellite. In some embodiments, nodes in network 100 may be equipped to perform FSOC, making network 100 an FSOC network. Additionally or alternatively, nodes in network 100 may be equipped to communicate via radio-frequency signals or other communication signals capable of travelling through free space. Arrows shown between a pair of nodes represent possible communication links 120, 122, 130, 131, 132, 133, 134, 135, 136, 137 between the nodes. The network 100 as shown in FIG. 1 is illustrative only, and in some implementations the network 100 may include additional or different nodes. For example, in some implementations, the network 100 may include additional HAPs, which may be balloons, blimps, airplanes, unmanned aerial vehicles (UAVs), satellites, or any other form of high-altitude platform.

In some implementations, the network 100 may serve as an access network for client devices such as cellular phones, laptop computers, desktop computers, wearable devices, or tablet computers. The network 100 also may be connected to a larger network, such as the Internet, and may be configured to provide a client device with access to resources stored on or provided through the larger computer network. In some implementations, HAPs 110 can include wireless transceivers associated with a cellular or other mobile network, such as eNodeB base stations or other wireless access points, such as WiMAX or UMTS access points. Together, HAPs 110 may form all or part of a wireless access network. HAPs 110 may connect to the data centers 105, for example, via backbone network links or transit networks operated by third parties. The data centers 105 may include servers hosting applications that are accessed by remote users as well as systems that monitor or control the components of the network 100. HAPs 110 may provide wireless access for the users, and may route user requests to the data centers 105 and return responses to the users via the backbone network links.

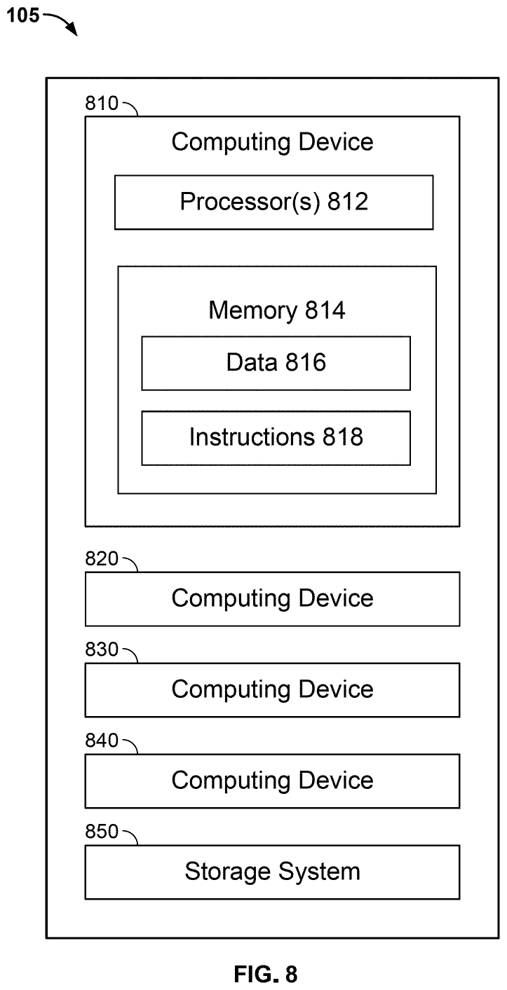

FIG. 8 is an example block diagram of the data centers 105. The data centers 105 may include one or more computing devices 810, 820, 830, 840 as well as a storage system 850. Each of these computing devices may include one or more processors 812, memory 814 and other components typically present in general purpose computing devices such as network connections to facilitate communications over the network 100.

The memory 814 stores information accessible by the one or more processors 812, including data 816 and instructions 818 that may be executed or otherwise used by the processor. The memory may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 818 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 816 may be retrieved, stored or modified by processor in accordance with the instructions. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processors 812 may be any conventional processors, such as commercially available CPUs or GPUs. Alternatively, the one or more processors may be a dedicated device such as an ASIC or other hardware-based processor. The processor, computing device, or memory may actually include multiple processors, computing devices, or memories that may or may not be stored within the same physical housing. For example, memory may be a hard drive or other storage media located in a housing different from that of computing device. Accordingly, references to a processor or computing device will be understood to include references to a collection of processors or computing devices or memories that may or may not operate in parallel.

In one example, the computing devices 810, 820, 830, 840 of the ground stations may include one or more server computing devices having a plurality of computing devices, e.g., a load balanced server farm, that exchange information with different nodes of a network (such as network 100 or another network) for the purpose of receiving, processing and transmitting the data to and from other computing devices, such as computing devices of the various HAPs of the network 100.

As with memory 814, storage system 850 can be of any type of computerized storage capable of storing information accessible by the server computing devices 810, 820, 830, 840, such as a hard-drive, memory card, ROM, RAM, DVD, CD-ROM, write-capable, and read-only memories. In addition, storage system 850 may include a distributed storage system where data is stored on a plurality of different storage devices which may be physically located at the same or different geographic locations. Storage system 450 may be connected to the computing devices via a network and/or may be directly connected to or incorporated into any of the computing devices 810, 820, 830, 840, etc.

Each of the computing devices may also include one or more wired or wireless network connections to facilitate communication with other computing devices, such as the those of network 100. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

Storage system 850 may store various types of information as described in more detail below. This information stored in the storage system 850 may be retrieved or otherwise accessed by a server computing device, such as the server computing devices 810, 820, 830, 840 in order to perform some or all of the features described herein.

### EXAMPLE AERIAL VEHICLE

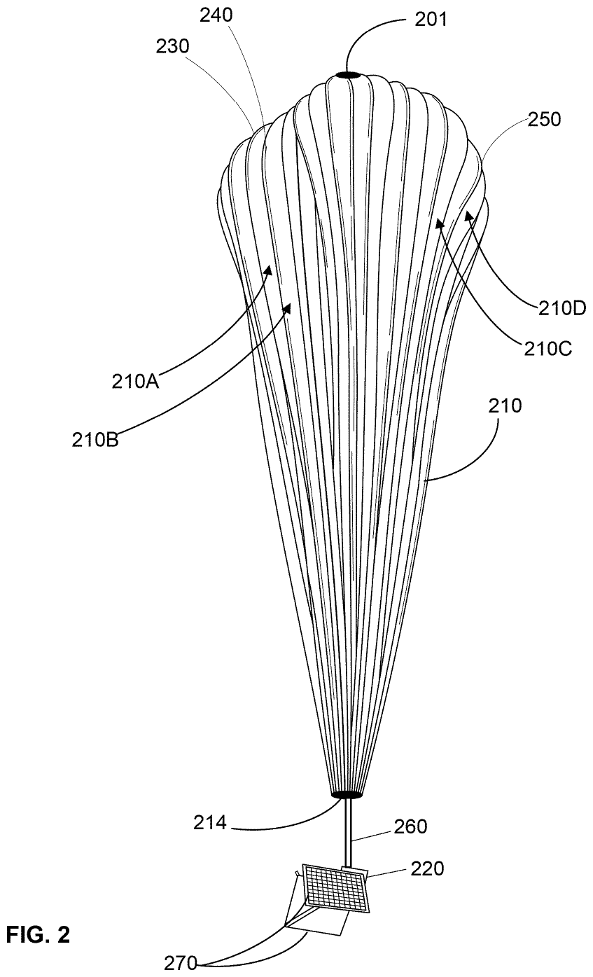

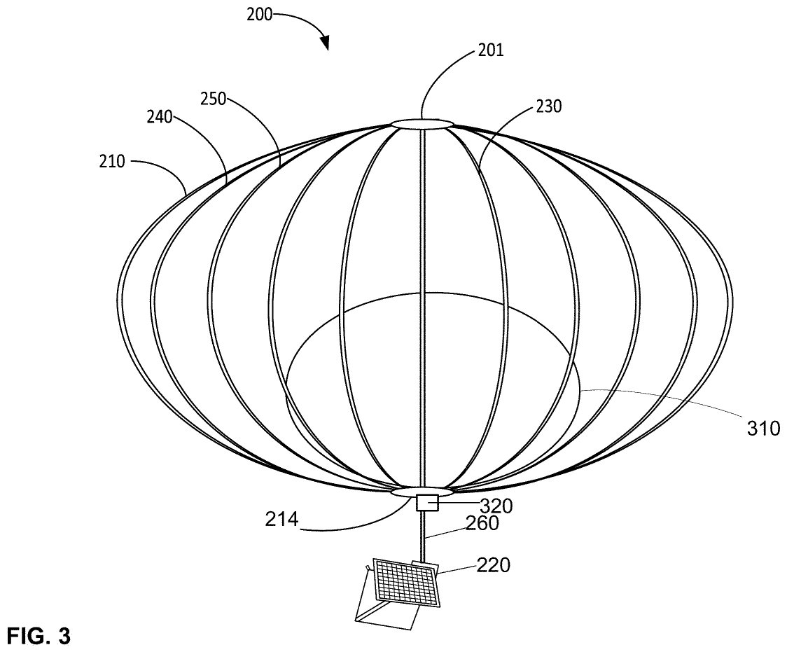

FIGS. 2 and 3 are examples of an aerial vehicle 200 which may correspond to HAP 110c, again, depicted here as a balloon. For ease of understanding, the relative sizes of and distances between aspects of the aerial vehicle 200 and ground surface, etc. are not to scale. As shown, the aerial vehicle 200 includes an envelope 210, a payload 220 and a plurality of tendons 230, 240 and 250 attached to the envelope 210. The envelope 210 may take various forms. In one instance, the envelope 210 may be constructed from materials (i.e. envelope material) such as polyethylene that do not hold much load while the aerial vehicle 200 is floating in the air during flight. Additionally, or alternatively, some or all of envelope 210 may be constructed from a highly flexible latex material or rubber material such as chloroprene. Other materials or combinations thereof may also be employed. Further, the shape and size of the envelope 210 may vary depending upon the particular implementation. Additionally, the envelope 210 may be filled with various gases or mixtures thereof, such as helium, or any other lighter-than-air gas. The envelope 210 is thus arranged to have an associated upward buoyancy force during deployment of the payload 220.

The payload 220 of aerial vehicle 200 may be affixed to the envelope by a connection 260 such as a cable and/or other rigid structures having various features as discussed further below. The payload 220 may include a computer system (not shown) including one or more computing devices having one or more processors and on-board data storage (e.g. memory). Such computing devices, processors and memory may be configured the same as or similarly to the computing devices, processors and memory of the data centers 105 described above. The payload 220 may also include various other types of equipment and systems (not shown) to provide a number of different functions. For example, the payload 220 may include various communication systems such as optical and/or RF, a navigation software module, a positioning system, a lighting system, an altitude control system (discussed further below), a plurality of solar panels 270 for generating power, and a power supply 280 (such as one or more of the batteries) to store power generated by the solar panels. The power supply may also supply power to various components of aerial vehicle 200.

In view of the goal of making the envelope 210 as lightweight as possible, it may be comprised of a plurality of envelope lobes or gores that have a thin film, such as polyethylene or polyethylene terephthalate, which is lightweight, yet has suitable strength properties for use as an envelope. In this example, envelope 210 comprises envelope gores 210A, 210B, 210C, 210D.

Pressurized lift gas within the envelope 210 may cause a force or load to be applied to the aerial vehicle 200. In that regard, the tendons 230, 240, 250 provide strength to the aerial vehicle 200 to carry the load created by the pressurized gas within the envelope 210. In some examples, a cage of tendons (not shown) may be created using multiple tendons that are attached vertically and horizontally. Each tendon may be formed as a fiber load tape that is adhered to a respective envelope gore. Alternatively, a tubular sleeve may be adhered to the respective envelopes with the tendon positioned within the tubular sleeve.

Top ends of the tendons 230, 240 and 250 may be coupled together using an apparatus, such as top plate 201 positioned at the apex of envelope 210. A corresponding apparatus, e.g., a bottom or base plate 214, may be arranged at a base or bottom of the envelope 210. The top plate 201 at the apex may be the same size and shape as and base plate 214 at the bottom. Both caps include corresponding components for attaching the tendons 230, 240 and 250 to the envelope 210.

FIG. 3 is an example of the aerial vehicle 200 in flight when the lift gas within the envelope 210 is pressurized. In this example, the shapes and sizes of the envelope 210, connection 260, envelope 310, and payload 220 are exaggerated for clarity and ease of understanding. During flight, these balloons may use changes in altitude to achieve navigational direction changes. In this regard, the inner envelope 310 may be a ballonet that holds ballast gas (e.g., air) therein, and the envelope 210 may hold lift gas around the ballonet. For example, the altitude control system of the payload 220 may cause air to be pumped into a ballast within the envelope 210 which increases the mass of the aerial vehicle and causes the aerial vehicle to descend. Similarly, the altitude control system may cause air to be released from the ballast (and expelled from the aerial vehicle) in order to reduce the mass of the aerial vehicle and cause the aerial vehicle to ascend. Alternatively, in a reverse ballonet configuration, the inner envelope 310 may hold lift gas therein and the envelope 210 may hold ballast gas (e.g., air) around the inner envelope 310, and the inner envelope 310 may hold the lift gas therein. In either case, the inner envelope 310 may be attached to one or both of the top plate 201 or the base plate 214 (attachment to the base plate being depicted in FIG. 3).

### EXAMPLE ALTITUDE CONTROL SYSTEM

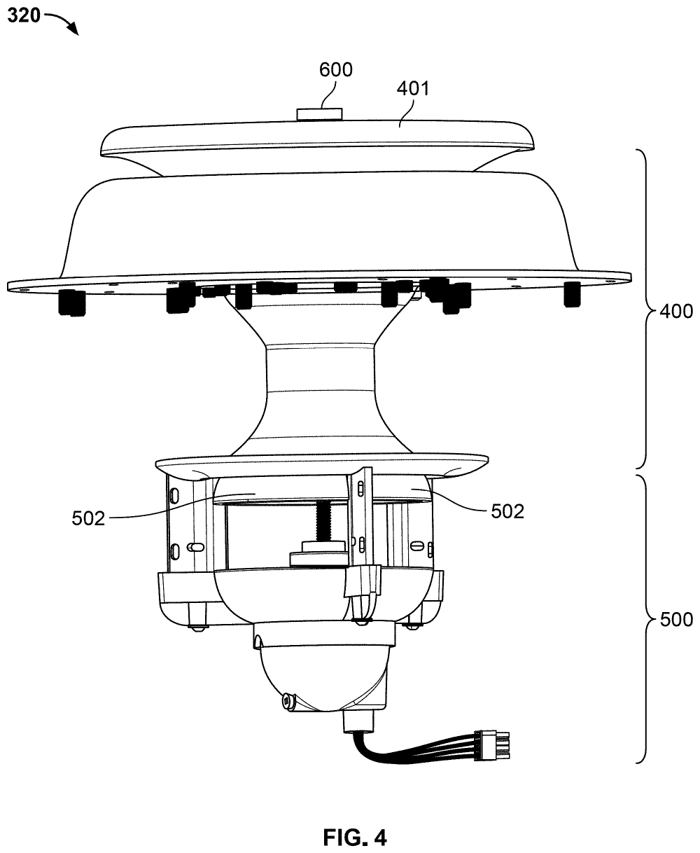

An altitude control system 320 may be positioned at the base plate 214 of the balloon to effect changes in altitude. FIG. 4 is an example altitude control system that includes a (1) compressor 400; (2) valve 500; and (3) control system 600. The compressor 400 can include a ballonet shroud 401 that can be directly joined to and positioned within an opening in the base plate 214. The valve 500 can be directly connected to an opening in the air compressor to regulate the amount of air into and the contents out of the compressor. The control system 600 can be positioned within an opening to the ballonet shroud 401.

The compressor 400 of the altitude control system can cause ballast gas (e.g. air) to be pumped into the inner envelope 310 within the envelope 210, which increases the density of the balloon and causes the balloon to descend. Similarly, a valve head 502 (see FIG. 4) of the valve 500 may retract from the inlet of the air compressor and may cause air to be released from the inner envelope 310 (and expelled from the balloon) in order to reduce the mass of the balloon and cause the balloon to ascend. The control system 600 may be mounted at the top of the compressor 400.

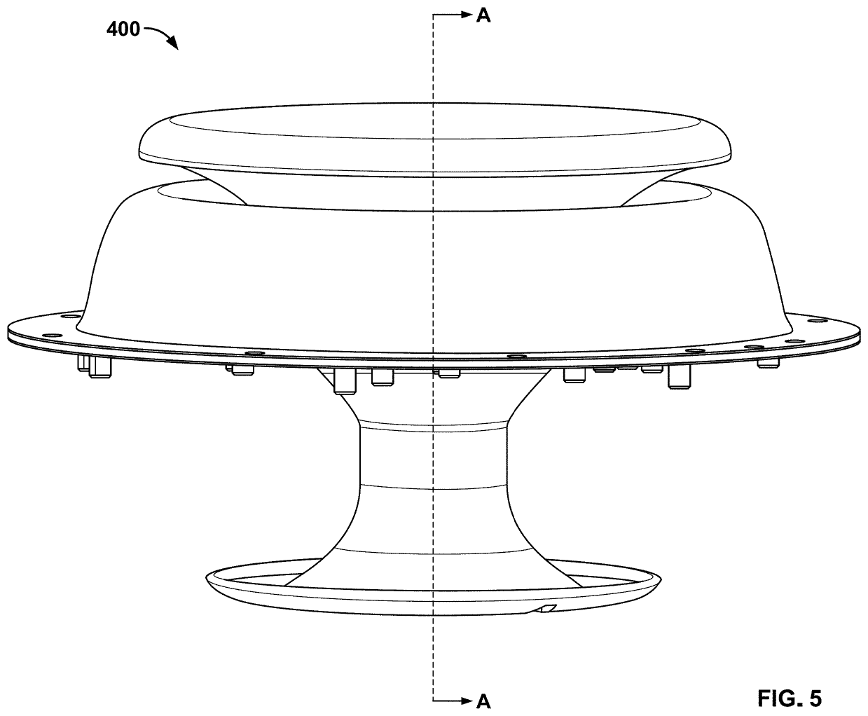

FIG. 5 is an example of compressor 400, which may be used, as noted above, with the altitude control system 320 of an unmanned aerial vehicle, such as a stratospheric balloon. The compressor 400 can be used to change the amount of air within an envelope (envelope 210 or inner envelope 310) by allowing for an increase or decrease in the amount of air provided to the envelope. For instance, a compressor can be configured to provide air to the stratospheric balloon at a rate and volume of air that will allow for flight at particular high altitudes. This change of air within the balloon envelope, as well as a change in air pressure caused by the compressor, can allow for a change in altitude and/or direction.

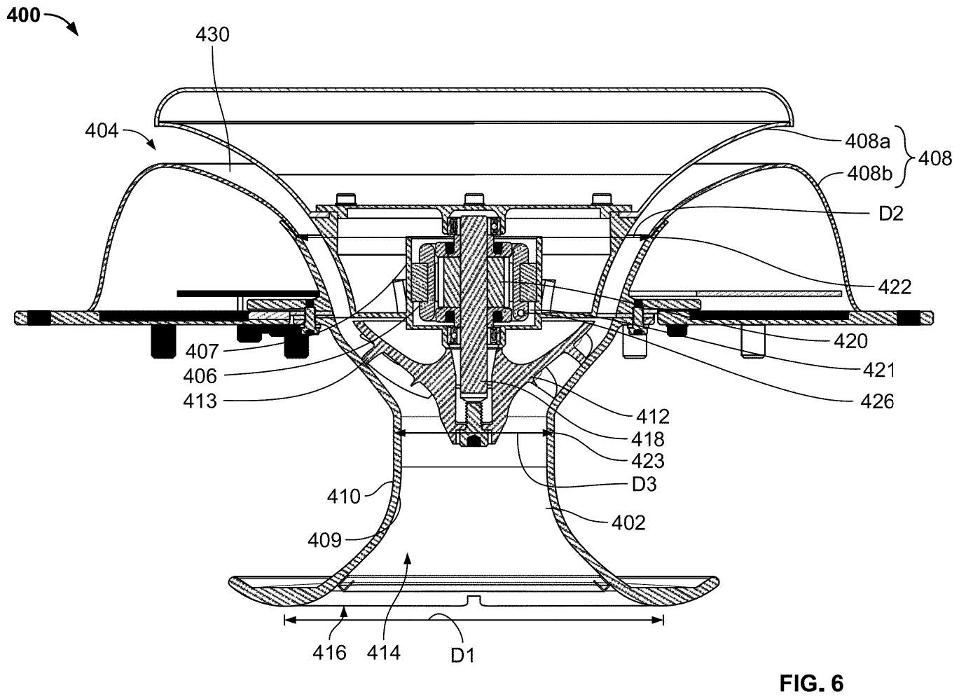

As shown in the cross-sectional view of FIG. 6, compressor 400 can include many structural features. For example, the compressor can include an inlet 402, an outlet 404, a motor 406, and a motor housing 407. The motor 406 and motor housing 407 can be positioned at the outlet. A diffuser 408 (defined by walls 408a and 408b) can overlie the motor 406, motor housing 407, a compressor housing 410, and an impeller 412. A cavity 414 or plenum of the compressor 400 can extend through a central portion of the compressor 400 and the compressor housing 410. In use, the motor 406 can cause rotation of a driveshaft 418, which is coupled to and causes rotation of the impeller 412, to accelerate and compress captured air, thereby causing the air to become pressurized.

The compressor housing 410 may be generally cylindrical with a circular cross-section. An entrance or opening 416 at the entrance to the inlet 402 of the compressor 400 can form an intake. The compressor housing 410 can define a cavity 414 therethrough to enable air or other fluid to flow into and out of the compressor housing 410 and the overall compressor 400. In one example, the cavity 414 extends entirely through the compressor housing 410, with the interior surface 409 of the compressor housing 410 forming a perimeter of the cavity 414. The opening 416 to the compressor housing 410 can have an inlet opening diameter D1 that is greater than the diameter of the compressor housing 410 at any point along the remainder of the cavity 414. This can allow for greater intake of air at the opening 416 to the inlet 402. Although generally illustrated as having a circular configuration, the compressor housing 410 may alternatively include any suitable configuration and need not include a circular cross-section. The compressor housing 410 may be formed of at least one of aluminum, brass, or stainless steel, although other types of material may be contemplated.

An impeller may be positioned within and occupy at least a portion of the inlet 402 of the compressor housing 410. For example, the impeller 412 may be positioned adjacent to the intermediate point 423 of the compressor housing 410 and closer to the first end 422 of the compressor housing 410. The impeller 412, along with the impeller blades 413, can help to draw air into and compress air entering into the compressor housing 410.

The impeller 412 may be coupled to a motor 406 and driveshaft 418, which can cause rotation of the impeller 412 via a rotor 420 and stator 421. A thermistor 426 arranged on the stator may be configured to communicate resistance measurements correlating to temperatures to a computing device, such as computing device 606 discussed further below or some other computing device of the aerial vehicle, such as a computing device of the payload 220.

The driveshaft 418 may be formed or otherwise manufactured from a stiff, rigid and strong material, including various metals such as carbon steel or other types of steel, to ensure that the driveshaft 418 can operate throughout the duration of the vehicle flight, as well as withstand external forces caused by, for example, extreme changes in temperature, back pressure from the envelope, etc. In some examples, the motor 406 can be a brushless DC, brushed DC, or any suitable motor so long as it is paired with a suitable controller to operate it.

In one example, the motor 406 and motor housing 407 can be positioned within the outlet 404 of the compressor and overlie the impeller 412. For example, as shown in FIG. 6, the impeller 412 may be positioned within the inlet 402 of the compressor 400, such that the impeller 412 is positioned between the motor housing 407 and the opening 416 of the inlet 402. Alternatively, the impeller may be arranged between the motor housing and the outlet 404.

The diffuser 408 may be configured to convert the mechanical work done by the motor 406 and impeller 412 of the compressor 400 back into potential energy in the form of pressurized air. Because of the shape of the diffuser 408, the diffuser changes the direction of the compressed air and slows and expands the air. As such, the diffuser can efficiently convert the kinetic energy of the compressed, flowing air into higher pressure, static air in the envelope 210 and/or inner envelope 310 of the balloon.

In use, the motor will rotate the impeller 412 so that the impeller may draw air into the inlet 402 of the compressor from the surrounding environment, for instance the external environment of the balloon. Air entering the impeller 412 will be accelerated through the impeller 412 and compressed and flow through the passageway 430 of the diffuser 408 and exit the compressor.

FIG. 8 schematically illustrates example components of the control system 600.

The control system 600 can include a computing device 606 and/or a controller 608 that can control the altitude control system 320. As an example, the computing device and/or controller may include one or more processors and memory storing data and instructions in order to enable the control system to perform the various functions described herein. Such computing devices, processors and memory may be configured the same as or similarly to the computing devices, processors and memory of the data centers 105 described above.

The control system 600 can also include various sensors that provide data to the computing device 606 that the computing device will use in making determinations regarding control of the altitude control system 320. For example, the control assembly can include the thermistor 426 (or rather, a connection to this device in order to enable feedback to be received by the computing device 606), an electronic speed control thermal sensor 612, a compressor housing thermal sensor 614, one or more barometers 616 which can be arranged at various locations of the aerial vehicle (e.g. the payload, the envelope, the compressor, etc.), a differential pressure sensor 618, a current sensor 620, and a gas sensor 622. The thermistor 426 may be configured to determine the temperature of the motor, the electronic speed control thermal sensor 612 can be configured to determine the temperature of the electronic speed control circuit controlling a motor of the valve 500, the compressor housing thermal sensor 614 can be configured to determine the temperature of the compressor housing of the system, the barometers 616 can be configured to determine the ambient pressure of the surrounding atmosphere as well as the ambient pressure within the envelope, and the differential pressure sensor 618 can be configured to compare the pressure between the surrounding atmosphere and the interior of the envelope (such as envelope 210 and/or the inner envelope 310) measured by the barometers 616. The electronic assembly can further include a printed circuit board assembly having processors and other circuit elements to control operation of the motor of the valve 500.

In one example, the computing device 606 may send a signal or data packet to the controller 608. The data packet may include the altitude corresponding with a heading or wind vector selected by the computing device 606. In response, the controller 608 may cause the unmanned aerial vehicle to adjust its altitude based on the predetermined flight path. For example, if the selected heading corresponds to an altitude that is lower than the current altitude of the aerial vehicle, the computing device 606 can cause the aerial vehicle to decrease its altitude. This can, for example, involve causing the valve to retract from the compressor inlet while the compressor 400 drives air into the envelope (such as envelope 210 and/or the inner envelope 310), thereby increasing the overall density of the system and causing a decrease in altitude to a lower point of neutral buoyancy. In this regard, a “descent cycle” may be a continuous period of time that the compressor 400 drives air into the envelope. The cycle starts and ends based on instruction from the controller 608.

Likewise, if a heading is selected by the computing device 606 that corresponds to an altitude that is higher than the current altitude of the aerial vehicle, the computing device can cause the aerial vehicle to increase its altitude. For example, the valve head 502 of the valve 500 may be opened to vent some or all of the contents (e.g. air and/or lift gas depending upon the envelope) of the envelope (which may be either the envelope 210 or the inner envelope 310, thereby causing the density of the system to decrease and the unmanned aerial vehicle to rise ensure that the envelope contents remain within the envelope.

### EXAMPLE METHODS

In order to assess the likelihood of failure of an altitude control system of an aerial vehicle, flight telemetry data may be accessed by one or more server computing devices, such as the server computing devices of the data centers 107. The flight telemetry may be sent by the aerial vehicles of the system, such as the aerial vehicle 200, and stored in the memory of the server computing devices 810, 820, 830, 840 or storage system 850 which can be accessed by the server computing devices.

The flight telemetry data used by the server computing devices may be collected during early-life altitude control system mechanical operations to develop a machine-learning model. The model may be one which shows low-variance, and in this case, bias may be acceptable in order to obtain a low-variance model. In other words, a model that is incorrect to a small degree may be preferable over one that is often correct often but can have larger errors in output values. For example, in the case of aerial vehicles, the result of a larger error in the output values of the model may be to remove the aerial vehicle from service. Therefore, the model may be selected to be both regularized and non-linear. For a model that is regularized, feature weights should be distributed across significant features instead of a model dominated by a feature that shows the highest correlation. This may reduce the occurrence of significant errors due to sensor or data processing issues. In addition, given the range of variation in operating environments and number of correlated features, using a non-linear model may be useful to handle scenarios with a disproportionately small sample size.

The model may be used to output “idealized impeller rotation rate” or “idealized shroud temperature” corresponding to an altitude control system that has endured minimal degradation. For the same power input, energy may be consumed as impeller rotation motion (measured through rotation rate) or dissipated as heat (measured through shroud temperature). Thus, either value may be used as a proxy for degradation of the altitude control system. The model may utilize a least squares regression or loss function or a random forest approach.

For the idealized impeller rotation rate, the model may be trained by the server computing devices using various training inputs and training outputs. The training inputs may include the aforementioned telemetry data. This telemetry data may include various values observed early in the life of compressors, such as compressor 400. Such values may include, for example, input power to a controller for the motor, current pressure ratio between the inlet and outlet of the compressor which can change at different altitudes (determined by the differential pressure sensor 618 and barometers 616), super-pressure or rather the backpressure on the impeller from within the envelope which can affect the speed of the impeller may be measured from internal gas density and temperature sensors of the envelope as well as an ambient temperature sensor located on top plate 201 and base plate 214, super-temperature or the ambient temperature inside of the envelope may be measured using resistance temperature detectors arranged at the top plate 201, base plate 214, or elsewhere which may affect air density and how fast the impeller can spin. When the model is to be used to determine an idealized impeller rotation rate, the training inputs may also include the ambient or shroud temperature of the compressor as the temperature of lubricant can change the efficiency of the compressor by becoming thicker or thinner which can affect friction in the motor. This temperature may be determined using feedback from the thermistor 426 arranged at the stator 421.

In this example, the impeller rotation rate observed early in the life of the compressor may be used as training outputs. Impeller rotation rate may be determined from feedback from a speed controller of the compressor's motor, e.g. from an internal tachometer which is based around measuring the back electromotive force (EMF) from the motor poles as they rotate inside the stator.

Alternatively, when the model is to be used to determine an idealized shroud temperature, the training inputs may also include the impeller rotation rate. As noted above, friction-based heat from the bearings and heat generated from losses in the motor stator may affect the motor shroud temperature during operation. The impeller rotation rate and relationship to temperature may be dependent on the aerodynamic and thermal transfer performance under these varying conditions. As such, the ambient or shroud temperature of the compressor observed early in the life of the compressor may be used as training outputs.

The model training may be performed by one or more of the server computing devices 810, 820, 830, 840 in advance, that is using training data accumulated from many different aerial vehicles with the same or similar configuration (i.e. similar features). Additional training may also be performed in real time for individual aerial vehicles. In ideal circumstances, all altitude control system units would be manufactured and calibrated identically. However, by training on a larger sample size of differently configured altitude control systems and aerial vehicles may help to generalize the model over variations between these features.

In practice, each altitude control system of the aerial vehicles of network 100 may be slightly different due to manufacturing and calibration variations. As a result, the model may first be trained on data from many vehicles, and subsequently “tuned” (e.g. transfer learning) using real-time data of an individual aerial vehicle. In such circumstances, the tuned model will only be used for the individual vehicle.

In order to improve the usefulness of the training data, certain preprocessing steps may be taken. For instance, unreliable data, such as extreme or unstable values with large absolute changes, may be ignored, filtered or otherwise removed from the training data. For example, the aerial vehicle's telemetry may send reports to the system out of order or during times of turbulence when pressure/altitude ratios are inconsistent or incorrect. As another example, data captured before a compressor has reached a steady state or a minimum number of descent cycles may be ignored, filtered or otherwise removed from the training data. As another example, certain types of descent cycles, such as very short ones may not have sufficient time to reach the steady-state or may have a very low sample size due to a low telemetry sampling rate. As such, descent cycles that do not last for at least a predetermined period of time may be ignored, filtered or otherwise removed from the training data. As another example, only data from similarly configured aerial vehicles may be used to train the model as noted above. In some instances, certain descent cycles may be used to cross-validate the model to avoid overfitting the model by confirming that the differential impeller rotation rate, Rdiff (discussed in more detail below), is close to 0 for early data that was used for training the model.

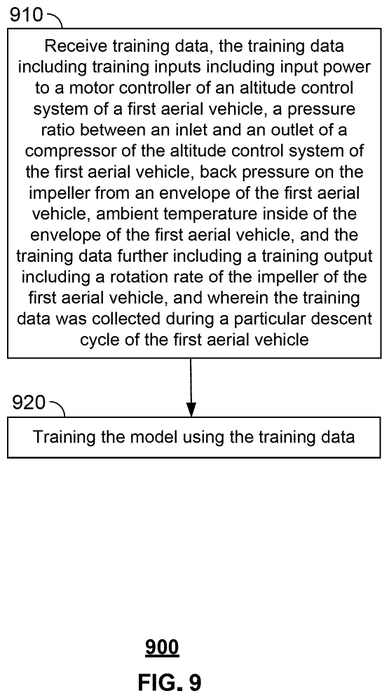

FIG. 9 is an example flow diagram 900 for training a model for determining an ideal impeller rotation rate for an impeller of an altitude control system of an aerial vehicle, such as impeller 412 of compressor of aerial vehicle 200. The features of the blocks may be performed, for example, by one or more processors of one or more computing devices, such as processors 812 of server computing devices 810, 820, 830, 840 or a computing device of the aerial vehicle 200. In this example, at block 910, training data is received. The training data includes training inputs including input power to a motor controller of an altitude control system of a first aerial vehicle, a pressure ratio between an inlet and an outlet of a compressor of the altitude control system of the first aerial vehicle, back pressure on the impeller from an envelope of the first aerial vehicle, ambient temperature inside of the envelope of the first aerial vehicle. The training data also includes a training output including a rotation rate of the impeller of the first aerial vehicle. The training data was collected during a particular descent cycle of the first aerial vehicle. At block 920, the model is trained using the training data.

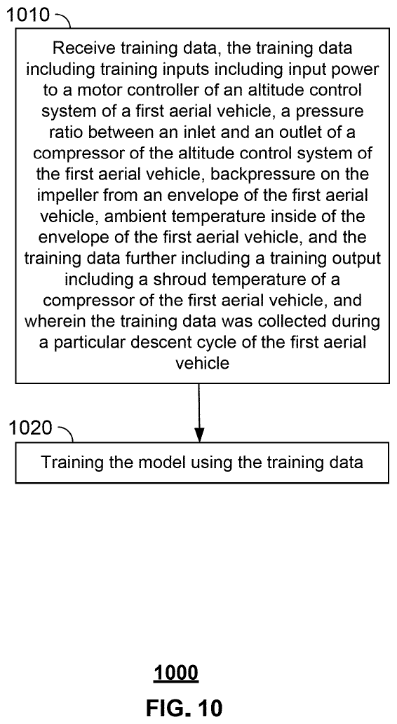

FIG. 10 is an example flow diagram 1000 for training a model for determining an ideal shroud temperature for an impeller of an altitude control system of an aerial vehicle, such as impeller 412 of compressor of aerial vehicle 200. The features of the blocks may be performed, for example, by one or more processors of one or more computing devices, such as processors 812 of server computing devices 810, 820, 830, 840 or a computing device of the aerial vehicle 200. In this example, at block 1010, training data is received. The training data includes training inputs including input power to a motor controller of an altitude control system of a first aerial vehicle, a pressure ratio between an inlet and an outlet of a compressor of the altitude control system of the first aerial vehicle, backpressure on the impeller from an envelope of the first aerial vehicle, as well as ambient temperature inside of the envelope of the first aerial vehicle. The training data also includes a training output including a shroud temperature of a compressor of the first aerial vehicle. The training data was collected during a particular descent cycle of the first aerial vehicle. At block 1020, the model is trained using the training data.

The model may then be used by the server computing devices and/or by a computing device of the aerial vehicle 200, such as computing device 606, in order to assess the likelihood of failure during flight of an aerial vehicle. This assessment may be performed by the server computing devices or the computing device of the aerial vehicle in real time in response to telemetry information from the various systems of the aerial vehicle is received either at a computing device of the aerial vehicle or at a remote computing device, such as a server computing device on the ground.

As altitude control system compressor usage increase, the impeller rotation rate may be expected to decrease due to degradation that occurs due to (1) mechanical loss due to increased friction (in part, caused by migration of lubricants such as grease) and (2) friction increase due to spalling or cracking on bearing surfaces. As a result, the impeller's rotation rate may be expected to decrease over time assuming ambient and operating variables are held constant. The measure of decrease may be considered a degradation measure. Similarly, observations of aerial vehicles which have failed have indicated an increase in shroud temperature in some instances prior to such failures. In this regard, the measure of increase may be considered a degradation measure.

Referring to the rotation rate example, likelihood of failure may be approximated by the differential impeller rotation rate, Rdiff. This value may be defined as the difference between the idealized impeller rotation rate, Ridealized, and an observed impeller rotation rate Robserved, or Rdiff=Ridealized-Robserved. During early compressor life, Rdiff is expected to be approximately zero. Overtime, the differential impeller rotation will increase as the efficiency of the altitude control system decreases.

In the shroud temperature example, likelihood of failure may be approximated by the differential shroud temperature Sdiff. This value may be defined as the difference between the idealized shroud temperature Sidealized and an observed shroud temperature Sobserverd, or Sdiff=Sidealized−Sobserved. During early compressor life, Sdiff is expected to be approximately zero. Overtime, the differential shroud temperature will decrease (become more negative) as the efficiency of the altitude control system decreases.

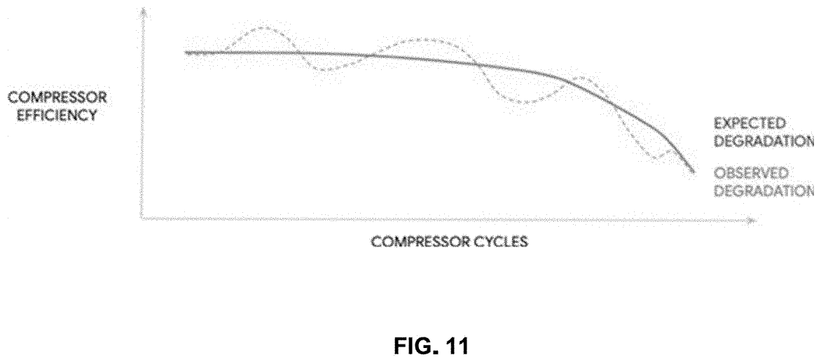

FIG. 11 is an example plot which demonstrates how compressor efficiency decreases as the number of descent cycles increases. The solid line represents how degradation of a compressor such as compressor 400 would be expected to occur over time, and the dashed line represents the observed degradation of a compressor such as compressor 400. Thus, as compressor efficiency decreases, the likelihood of failure may increase.

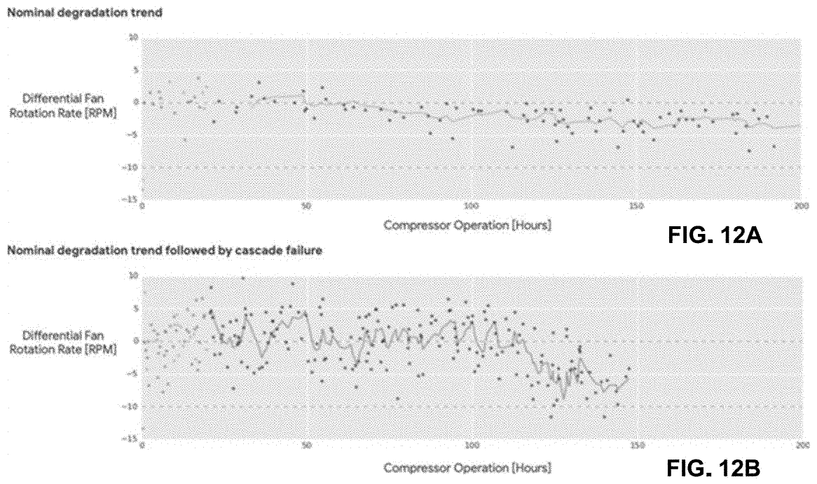

FIGS. 12A and 12B are example plots which demonstrate how the differential fan rotation rate (Rdiff) decreases over time. FIG. 12A represents a nominal degradation trend, while FIG. 12B represents a nominal degradation trend followed by a cascade failure of the compressor. In this example, each “dot” represents the differential fan rotation rate for a particular descent cycle.

At a certain point, the likelihood of failure may be such that some intervention action may need to be taken. In other words, eventually Rdiff will be high enough or Sdiff will be low enough to require some intervention action. For instance, the Rdiff or Sdiff may be compared to a threshold value. If the threshold value is met, the aerial vehicle can be controlled to land at a designated landing area. The threshold value may be determined by the amount of time required for the aerial vehicle to reach the designated landing area or a distance that the aerial vehicle needs to travel to reach the designated landing area.

The intervention action may include providing a notification for display to a human operator. This may include displaying a flag on a display of a computing device, such as a computing device of the data centers 105 or another computing device, in order to indicate that the aerial vehicle needs further consideration and to enable the human operator to command the aerial vehicle to terminate flight and land in a designated landing area. Alternatively, that the flight of the aerial vehicle should be terminated may be automatically determined by the server computing devices 810, 820, 830, 840 or a computing device of the aerial vehicle 200 prior to a total failure occurring. In such an example, the system may identify a closest or other designated landing area. As another alternative, rather than terminating the flight of an aerial vehicle, the server computing devices 810, 820, 830, 840 may also use the degradation measure to assign flights or missions to the aerial vehicles. For example, aerial vehicles with degradation beyond a validated threshold may only be assigned for short-duration missions.

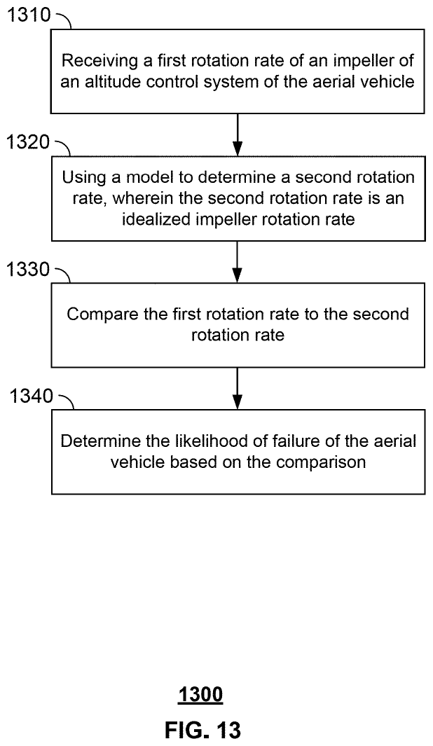

FIG. 13 is an example flow diagram 1300 for determining a likelihood of failure of an aerial vehicle, such as aerial vehicle 200. The features of the blocks may be performed, for example, by one or more processors of one or more computing devices, such as processors 812 of server computing devices 810, 820, 830, 840 or a computing device of the aerial vehicle 200. In this example, at block 1310, a first rotation rate of an impeller of an altitude control system of the aerial vehicle is received. This first rotation rate may be an actual rotation rate of an impeller of a compressor of the aerial vehicle, such as impeller 412 of compressor 400 of aerial vehicle 200.

At block 1320, a model is used to determine a second rotation rate. The second rotation rate is an idealized impeller rotation rate. In this regard, the model may be the aforementioned machine learned model for determining idealized rotation rates. To determine the second rotation rate, current telemetry data from the aerial vehicle may be input into the model such as input power to a motor controller of an altitude control system of the aerial vehicle, a pressure ratio between an inlet and an outlet of a compressor of the altitude control system of the aerial vehicle, back pressure on the impeller from an envelope of the aerial vehicle, as well as ambient temperature inside of the envelope of the first aerial vehicle measured as described, for example, above.

At block 1330, the first rotation rate may be compared to the second rotation rate. This difference may represent the Rdiff value. In this regard, the first rotation rate may be considered the Robserved, and the second rotation rate may be considered the Ridealized.

At block 1340, the likelihood of failure of the aerial vehicle is determined based on the comparison. In other words, Rdiff may represent a likelihood of failure, or may be converted to some value representative of a likelihood of failure. Rdiff or the value representative of a likelihood of failure may then be compared to a threshold value to determine whether an intervention action, such as those described above, should be initiated.

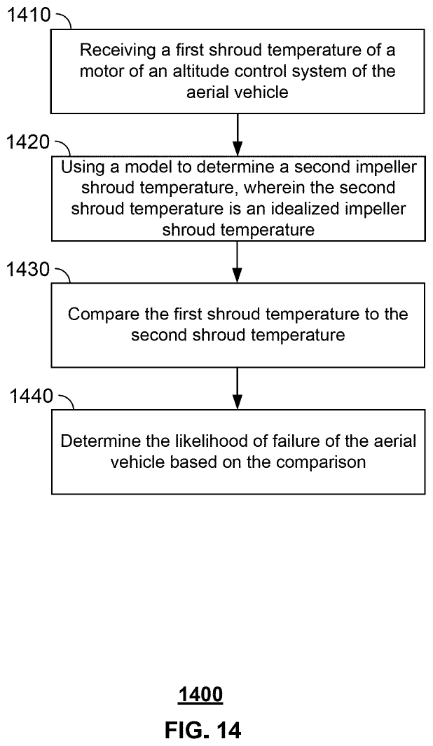

FIG. 14 is an example flow diagram 1400 for determining a likelihood of failure of an aerial vehicle, such as aerial vehicle 200. The features of the blocks may be performed, for example, by one or more processors of one or more computing devices, such as processors 812 of server computing devices 810, 820, 830, 840 or a computing device of the aerial vehicle 200. In this example, at block 1410, a first shroud temperature of a motor of an altitude control system of the aerial vehicle is received. This first shroud temperature may be an actual temperature of a motor of the aerial vehicle, such as motor 406 of compressor 400 of aerial vehicle 200. This temperature may be measured, for example, using the thermistor 426.

At block 1420, a model is used to determine a second shroud temperature. The second rotation rate is an idealized shroud temperature. In this regard, the model may be the aforementioned machine learned model for determining idealized shroud temperatures. To determine the second rotation rate, current telemetry data from the aerial vehicle may be input into the model such as input power to a motor controller of an altitude control system of the aerial vehicle, a pressure ratio between an inlet and an outlet of a compressor of the altitude control system of the aerial vehicle, backpressure on the impeller from an envelope of the aerial vehicle, as well as ambient temperature inside of the envelope of the first aerial vehicle measured as described, for example, above.

At block 1430, the first rotation rate may be compared to the second rotation rate. This difference may represent the Sdiff value. In this regard, the first shroud temperature may be considered the Sobserved, and the second shroud temperature may be considered the Sidealized.

At block 1440, the likelihood of failure of the aerial vehicle is determined based on the comparison. In other words, Sdiff may represent a likelihood of failure, or may be converted to some value representative of a likelihood of failure. Sdiff or the value representative of a likelihood of failure may then be compared to a threshold value to determine whether an intervention action, such as those described above, should be initiated.

The features described herein may provide for a useful way to assess likelihood of failure of an aerial vehicle related to the aerial vehicle's altitude control system or compressor. Typical approaches for estimating likelihood of failure may analyze the temperature of the features of the altitude control system, to determine whether the compressor is overheating. However, the increase in temperature to the point of overheating typically occurs after the change in rotation rate and in many instances after it may be too late to safely navigate the aerial vehicle to a designated landing area. In that regard, a prognostic model to trend versus the telemetry observation of gross failure which relies on rotation rate or shroud temperature as described herein can actually allow for assessment of a likelihood of failure earlier in time as compared to using temperature measurements alone.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for determining a likelihood of failure of an aerial vehicle, the method comprising:
receiving, by one or more processors, a first rotation rate of an impeller of an altitude control system of the aerial vehicle;
using, by one or more processors, a model to determine a second rotation rate, wherein the second rotation rate is an idealized impeller rotation rate;
comparing, by one or more processors, the first rotation rate to the second rotation rate; and
determining, by one or more processors, the likelihood of failure of the aerial vehicle based on the comparison.

2. The method of claim 1, wherein the one or more processors are one or more processors of the aerial vehicle.

3. The method of claim 1, wherein the one or more processors are one or more processors of a computing device remote from the aerial vehicle.

4. The method of claim 1, wherein the model is a machine learned model.

5. The method of claim 1, further comprising:
comparing the likelihood of failure to a threshold value; and
initiating an intervention action based on the comparison of the likelihood of failure to the threshold value.

6. The method of claim 5, wherein the intervention action includes sending a notification for display to a human operator.

7. The method of claim 5, wherein the intervention action includes automatically causing the aerial vehicle to terminate a flight of the aerial vehicle.

8. The method of claim 5, further comprising, determining the threshold value based on an amount of time for the aerial vehicle to reach a designated landing area.

9. The method of claim 5, further comprising, determining the threshold value based on a distance the aerial vehicle needs to travel to reach a designated landing area.

10. A method of training a model for determining an ideal impeller rotation rate for an impeller of an altitude control system of an aerial vehicle, the method comprising:
receiving, by one or more processors, training data, the training data including training inputs including input power to a motor controller of an altitude control system of a first aerial vehicle, a pressure ratio between an inlet and an outlet of a compressor of the altitude control system of the first aerial vehicle, back pressure on the impeller from an envelope of the first aerial vehicle, ambient temperature inside of the envelope of the first aerial vehicle, and the training data further including a training output including a rotation rate of the impeller of the first aerial vehicle, and wherein the training data was collected during a particular descent cycle of the first aerial vehicle; and
training the model using the training data.

11. The method of claim 10, wherein the training inputs further include shroud temperature of the compressor of the first aerial vehicle.

12. The method of claim 10, wherein the particular descent cycle is a descent cycle of the altitude control system of the first aerial vehicle which occurs after a steady-state has been reached.

13. The method of claim 10, wherein the particular descent cycle is a descent cycle of the altitude control system of the first aerial vehicle which occurs after a minimum number of descent cycles have been completed.

14. The method of claim 10, wherein the particular descent cycle is a descent cycle of the altitude control system of the first aerial vehicle having a minimum number of samples.

15. The method of claim 10, wherein the particular descent cycle is a descent cycle of the altitude control system of the first aerial vehicle lasting at least a predetermined period of time.

16. A method of training a model for determining an ideal shroud temperature for an impeller of an altitude control system of an aerial vehicle, the method comprising:
receiving, by one or more processors, training data, the training data including training inputs including input power to a motor controller of an altitude control system of a first aerial vehicle, a pressure ratio between an inlet and an outlet of a compressor of the altitude control system of the first aerial vehicle, backpressure on the impeller from an envelope of the first aerial vehicle, ambient temperature inside of the envelope of the first aerial vehicle, and the training data further including a training output including a shroud temperature of a compressor of the first aerial vehicle, and wherein the training data was collected during a particular descent cycle of the first aerial vehicle; and
training the model using the training data.

17. The method of claim 16, wherein the particular descent cycle is a descent cycle of the altitude control system of the first aerial vehicle which occurs after a steady-state has been reached.

18. The method of claim 16, wherein the particular descent cycle is a descent cycle of the altitude control system of the first aerial vehicle which occurs after a minimum number of descent cycles have been completed.

19. The method of claim 16, wherein the particular descent cycle is a descent cycle of the altitude control system of the first aerial vehicle having a minimum number of samples.

20. The method of claim 16, wherein the particular descent cycle is a descent cycle of the altitude control system of the first aerial vehicle lasting at least a predetermined period of time.
